(19) United States
(12) Patent Application Publication
(10) Pub. No.: US 2024/0392847 A1
(43) Pub. Date: Nov. 28, 2024

(54) DEVICE WITH A MAGNETORHEOLOGICAL BRAKING DEVICE AND METHOD

(71) Applicant: INVENTUS Engineering GmbH, St. Anton i.M. (AT)

(72) Inventor: Stefan Battlogg, St. Anton i.M. (AT)

(21) Appl. No.: 18/573,462

(22) PCT Filed: Jul. 5, 2022
(86) PCT No.: PCT/EP2022/068556

§ 371 Date: Dec. 22, 2023

(30) Foreign Application Priority Data
Jul. 6, 2021 (DE) 10 2021 117 398.1
Jul. 14, 2021 (DE) 10 2021 118 223.9

(51) Int. Cl. F16D 57/00; F16D 57/02

(52) U.S. Cl. CPC F16D 57/002; F16D 57/02

(57) ABSTRACT

A device having a magnetorheological brake device and a method for braking relative movements with at least two brake components. A receiving space with a brake gap is formed between the brake components and contains a magnetorheological medium which can be influenced by a magnetic field and which includes magnetically polarizable particles. The device has at least one electrical coil unit to generate a controllable magnetic field in the brake gap. At least some of the magnetically polarizable particles are designed to form an engagement structure under the influence of the magnetic field and to group together in a controlled manner due to the magnetic field.

The present invention relates to a device with an magnetorheological braking device for braking relative movements and a corresponding method. A device according to the invention or the magnetorheological braking device comprises at least two braking components, between which at least one receiving space is formed with at least one braking gap, the braking gap being at least partially filled with a magnetorheological medium containing polarizable particles that can be influenced by a magnetic field.

A wide variety of magnetorheological braking devices have become known in the prior art, which are used for braking or for damping relative movements.

A major application of magnetorheological fluids is in a shock absorber, where the magnetorheological fluid flows from one chamber to another chamber. Both high pressures and flow velocities can prevail here. The magnetorheological fluid or the magnetorheological liquid contains a multiplicity of correspondingly small, round particles in order to advantageously allow the overflow from one chamber into the other chamber in terms of flow technology. A low flow resistance is important in order to achieve low basic damping.

Furthermore, magnetorheological braking devices have become known in which the braking of the two braking components that can be moved relative to one another is braked via a shear stress between two, for example, plate-shaped surfaces. Between The magnetorheological fluid is located on the plates. The magnetic field flows through the magnetorheological fluid perpendicularly to the direction of movement of the plate-shaped surfaces. Such shear stress is used in particular in clutches and brakes. If a magnetic field is applied, the viscosity changes very quickly, since only the magnetically polarizable particles have to be aligned. This means that force changes can be implemented within a few milliseconds. In a magnetic field-free space, the shear stress behaves like a Newtonian fluid and in a magnetic field like a Bingham fluid. The particles are polarized by the magnetic field and form chains in the direction of the field lines.

JP 2013181 598 A deals with the problem that clumping can occur in magnetorheological liquids due to particle sedimentation. This can occur, for example, if a magnetorheological brake is not moved for a long time. In addition, JP 2013181 598 A deals with the problem that the viscosity of the magnetorheological fluid can increase when it rotates at high speed or shear rate. The proposed solution is for the magnetorheological fluid to have second, nano-sized particles in addition to the first particles (e.g. carbonyl iron particles). This mixture reduces the increase in viscosity of the magnetorheological fluid at high speeds and at the same time prevents sedimentation. In addition, both particle types are each coated with a surface modification layer. This improves the affinity for the dispersing agent (e.g. silicone oil).

In certain applications, magnetorheological braking devices are desired which are particularly compact and can provide a particularly high braking torque. In the case of a rotary brake with small diameters of, for example, 60 mm or smaller and a cylindrical brake gap, it is difficult to generate a high field strength in the brake gap (effective gap) because the central core or other parts in the magnetic circuit saturate first. A high coil current of the electrical coil therefore does not lead to any improvement if parts of the magnetic circuit are in saturation. The smaller the diameter becomes, the sooner the core saturates and the less favorable the magnetic circuit surfaces become with one another. This means that smaller actuators have even lower flux densities in the brake gap.

To increase the braking force, the applicant's EP 2 616 704 B1 discloses a structure in which rotating parts, such as rollers, are arranged in the brake gap. These rollers specifically influence the course of the magnetic field, which acts on the magnetically polarizable particles (for example carbonyl iron particles) in the magnetorheological fluid. Due to the magnetic field effect on the magnetically polarizable particles, a (geometric) wedge is formed in front of the rotating round surfaces of the rollers or rotating bodies, which consists of accumulated particles. The rollers can therefore also be referred to as magnetic field concentrators. This increases the braking torque.

With the applicant's DE 102020 106328 B3, another structure has become known in which the magnetically polarizable particles such as carbonyl iron particles form a (local) cluster in the braking gap due to a special contour of the contact surfaces of the braking gap and higher shear forces due to the resulting increased particle concentration effect, whereby higher braking torques can be generated. Here, for example, the radially inner braking component is formed by a star or gear-like structure, so that the braking gap has a variable gap height over the circumference, for example if the outer braking component is cylindrical on the inner circumference.

In such a configuration, strong concatenation and accumulation of particles realized because the braking gap does not have a constant height all around, but tapers periodically, so that clusters of particles accumulate adjacent to these areas. Wedge-shaped heaps of the magnetically polarizable particles form adjacent to the constrictions, causing an increased braking torque.

In principle, the configurations according to DE 10 2020 106 328 B3 or EP 2616704 B1 function satisfactorily, with the latter construction, in which rotary bodies are used in the braking gap, even higher braking torques being achievable than in the variant where, for example, a star contour in the brake gap ensures a variable gap height. Although satisfactory results are achieved, there is a desire to noticeably increase the maximum locking torque or the maximum locking force, especially given the same starting position and the same framework conditions (similar construction volume and similar material), and thus to achieve a higher power density.

This object is solved by a device having the features of claim 1 and by the method defined in the claims. Preferred developments of the invention are the subject matter of the dependent claims. Further advantages and features of the present invention result from the general description and the exemplary embodiments.

A device according to the invention comprises one or at least one magnetorheological braking device for braking relative movements. The braking device comprises at least two braking components, with a receiving space having at least one braking gap being formed between the braking components. The receiving space (and the braking gap) contains at least one magnetorheological medium that can be influenced by a magnetic field and has magnetically polarizable particles (magnetorheological particles). Furthermore, at least one core and at least one electrical coil unit are included in order to generate a controllable magnetic field to generate in the braking gap. At least some of the magnetically polarizable particles are designed to form an engagement structure under the influence of the magnetic field and to clamp or wedge them together. (This effectively forms a wedge at the particle level.)

The device according to the invention has many advantages. A significant advantage of the device according to the invention is that the magnetorheological particles of the magnetorheological medium are designed in such a way that they can form an engagement structure with one another, which engage or latch with one another and thus form a significantly stronger structure. This makes it possible to generate a significantly greater braking torque than was possible in the prior art. The magnetically acting forces are mechanically amplified by the engagement structure.

Conventional magnetorheological particles, on the other hand, have to be pressed together so tightly by the magnetic field alone that the desired braking torque can be transmitted. If the magnetic field is not strong enough, the conventional magnetorheological particles slide along each other. In contrast to this, the magnetorheological particles of the invention can engage on one another, so that they cannot easily slide along one another even with lower magnetic forces.

In particular, a magnetic field strength greater than 500 kA/m can be generated between the individual magnetically polarizable particles.

Preferably, a minimum gap height of the braking gap between the braking components is less than ten times or eight times or five times a mean diameter of a typical magnetorheological particle in the braking gap. The average diameter of a typical magnetorheological particle can be an operand that is particularly calculated by adding half of the (absolute) largest diameter of a particle plus half of the largest diameter perpendicular to it.

A typical magnetically polarizable particle is preferably selected for the calculation of the average diameter, which is arranged in the center field of all particles in particular in terms of size. It is also possible that for a typical particle and in particular the mean diameter of a typical magnetorheological particle, the mean value is taken from the diameter of the largest particle and the smallest particle.

It is also possible to calculate the mean diameter of a typical particle by dividing the volume of all particles in the receiving space by the number of all particles in the receiving space, in order to obtain the typical volume of a typical particle. A diameter of a spherical particle with the same volume can then be determined from this. The diameter calculated in this way is then defined as the typical diameter.

Instead of all particles, only those particles can be included in the calculation that produce, for example, between 80% and 90% of the total particle volume. For example, smaller particles could be screened if e.g., many smaller particles are present. Many small and tiny particles could falsify the calculated result of a mean diameter of a typical particle and push it down.

In all configurations it is preferred that the magnetically polarizable particles are formed in particular by carbonyl iron particles.

If a magnetorheological fluid is used, then liquids available on the market at 40% by volume. (Own) mixtures with between 40 and 50 percent by volume carbonyl iron are possible. More is not possible, since the carrier liquid takes up the remaining volume.

If powder is used without a carrier liquid, up to about 80 percent by volume of carbonyl iron (iron powder) is possible, which greatly increases the braking torque if the remaining design parameters are adjusted accordingly (e.g. the field strength per particle should remain somewhat the same as with MR liquid, i.e. the field strength in the braking gap or active gap should be twice as high when changing from LORD MRF 140 (40 percent by volume carbonyl iron with e.g. oil as carrier liquid) to 80% carbonyl iron powder (without carrier liquid). We are talking about magnetic field strength in the gap of more than 200 kA/m up to values of up to 1,000 kA/m (1000000 A/m) or above.

Another advantage of powder as a medium in the effective gap is that there is no sedimentation and no accumulation in the sense of “the iron particles in MR liquids are pulled in the direction of the magnetic field gradient (the force on magnetizable particles always acts in the direction of the stronger magnetic field, the carrier medium is displaced)” must occur in order to obtain such high particle concentrations. The maximum particle concentration is already present). This improves the reproducibility of the torques (a similar braking torque always occurs with the same current).

In all configurations, it is particularly preferred that the magnetically polarizable particles (to a significant extent) comprise non-round particles (non-spherical particles) in which the ratio of the largest diameter to the largest transverse extension perpendicular thereto is greater than 1.25 or 1.5. It is also possible to form this ratio as a ratio of the greatest longitudinal extent to the greatest transverse extent, with the longitudinal and transverse extensions are measured perpendicular to each other.

The use of out-of-round particles is particularly advantageous since they enable an effective engagement structure, since different out-of-round sections of the particles latch or wedge with one another.

Ratios of the largest diameter to the largest transverse extension perpendicular thereto of 1.75 or 2.0 or more are also possible and preferred.

At least some of the magnetically polarizable particles are preferably designed to clamp or wedge together over a large area under the influence of the magnetic field. This is possible, for example, with particles that are angular in sections or, for example, are triangular or polygonal overall or the like. Two (or more) correspondingly configured particles then latch together and can cause the particles to clump together very effectively and cause the two brake components to latch and brake together.

At least some of the magnetically polarizable particles are preferably designed to clamp or wedge together under the influence of the magnetic field at two or more locations spaced apart from one another. Such particles, which are non-circular, allow a very effective increase in braking force or braking torque, since, unlike spherical particles, they do not only touch at one point or in a small angular range, but at several points or even over an area.

Preferably, at least some of the magnetically polarizable particles have at least one trough section.

Such an inwardly curved trough section allows a particularly effective wedging with parts of other particles.

Preferably, at least one surface of at least one brake component adjoining the brake gap is at least partially non-smooth or (locally) uneven. It is also possible that the particles or a significant part of the magnetically polarizable particles have elevations or elevations and/or depressions regularly or irregularly on the outer surface. As a result, engagement with the particles can be reinforced. For example, at least one surface can have elevations and/or depressions in the manner of pointed or rounded dimples in golf balls. A surface with a pointed or rounded sawtooth profile is also possible. A relative height (at least some) of the peaks or valleys is preferably at least 5% or 10% of the minimum diameter of a magnetically polarizable particle.

In advantageous configurations, at least some of the magnetically polarizable particles have at least one angled structural section. Angled structures allow particularly effective clamping with one another, so that a high braking torque can be generated.

In all configurations, it is preferred that a projection or edge of one particle interlocks with a recess or trough portion of another particle.

It has surprisingly turned out that particularly high braking forces can be transmitted with non-round particles, while on the other hand a low basic torque can also be generated. The idling torque (basic torque) decreases due to the reduction in the effective surfaces (the surfaces moving at a small distance from one another—these primarily generate the basic friction—are reduced), which is very advantageous. The engagement of the magnetically polarizable particles can take place not only two-dimensionally, but three-dimensionally (thus e.g. also in the axial direction . . . ).

It has been found that a particularly effective engagement and latching of individual particles can be generated with high magnetic field strengths. For this purpose, a magnetic field strength of greater than 150 kiloamperes/meter (kA/m) or 250 kiloamperes/meter or 500 kA/m or more is preferably generated in the braking gap. In particular, a magnetic field strength greater than 500 kiloamperes/meter (kA/m) or kiloamperes/meter or 1000 kA/m or more can be generated in the brake gap or is generated there.

For a particularly effective increase in the braking torque that can be achieved or the braking force that can be achieved, it has proven to be very advantageous to reduce the minimum gap height of the braking gap between the braking 3 components compared to the dimensions in the prior art. It is preferred that the minimum gap height is less than five times the largest diameter of the magnetically polarizable particles in the braking gap. In particular, however, a minimum gap height of the braking gap between the braking components is greater than twice the maximum transverse extent perpendicular to the maximum diameter of the magnetically polarizable particles in the braking gap. It is also possible and preferred that the minimum gap height of the braking gap between the braking components is greater than three times the maximum transverse extent perpendicular to the maximum diameter of the magnetically polarizable particles in the braking gap. This ensures a low basic torque or a low basic force, while at the same time a particularly high braking torque or a particularly high braking force can be generated.

Preferably at least 10% and more preferably at least 20% of the magnetically polarizable particles are present ratio of maximum diameter to maximum transverse extent of greater than 1.25 or greater than 1.5 or greater than 2.0.

In the case of at least 33% or at least 50% of the magnetically polarizable particles, a ratio of maximum diameter to maximum transverse extent perpendicular thereto of greater than 1.25 or greater than 1.5 or greater than 2.0 is particularly preferred.

In particular, at least 10% or 25% or 33% or 50% of the magnetically polarizable particles have a maximum diameter and/or a maximum transverse extent of at least 10 μm. It has been found that a higher braking effect can be achieved with larger particles than with smaller particles. It is therefore preferred that at least 10%, 25% or 33% or 50% of the magnetically polarizable particles have a maximum diameter of at least 20 μm or at least 30 μm or at least 50 μm. Smaller particles can be included.

Surprisingly, it turned out that a lower basic torque and a higher braking torque (or basic force and braking force) can be achieved with larger particles.

In all configurations it is preferred that at least one load sensor such as a torque sensor or torque recorder or torque observer and/or a force sensor is included. It is also preferred that at least one position sensor for detecting an angular position and/or relative position is included.

The coil unit or at least one coil unit can have a (cylindrical) coil wire. It is possible for the coil wire to consist of flat material. It is also possible to use a wire with an adapted contour made of copper or another suitable material. The device preferably comprises at least one control unit for controlling the electrical coil unit. It is possible and preferred that the control unit takes into account signals from the load sensor for controlling the electrical coil units. It has been found that a high braking torque or a high braking force can occur almost suddenly if a sufficient number of particles are latched together. Then (according to the current idea) a larger, firmer lump forms, which ensures a significant increase in the braking torque or braking force. In order to be able to control the acting braking force or the acting braking torque in a targeted manner, it is advantageous to control the magnetic field as a function of the signal from a load sensor.

In preferred configurations, the two brake components can be pivoted relative to one another. However, it is also possible for the two brake components to be movable linearly with respect to one another.

The two brake components are particularly preferably continuously rotatable relative to one another. It is possible that a brake component forms an inner component and the other component comprises an outer component. The outer component radially surrounds the inner component at least in sections. In preferred developments, the core is formed on the inner component. The inner component is preferably coupled to an axle unit. The outer component can then be rotatably received around the inner component.

The electrical coil unit or multiple coil units may be wound radially and/or axially around the core.

It is possible for the core to have at least one radially protruding arm around which at least one winding of the electrical coil unit is wound. In preferred embodiments, a plurality of radially outwardly extending arms are included. Preferably, there are those extending radially outward Arms made of a material of higher magnetic permeability. Intermediate sections with lower magnetic permeability are formed between the arms. Preferably, a ratio of the magnetic permeability of an arm to a magnetic permeability of an intermediate section is greater than 10 or 100 or greater than 1000. It is preferred that a proportion of the length of the intermediate sections in the (circumferential) length of the brake gap is greater than 33% and in particular greater than 40% or 50% or 60%. As a result, the magnetic field is concentrated in the area of the arms bordering the brake gap and is thus locally amplified.

It is preferred that the braking gap completely radially surrounds the inner component. The braking gap can in particular be designed as a circumferential annular gap.

It is possible and preferred for at least one brake component to have a star contour or the like projecting towards the other brake component, which creates or makes available a gap height that is variable over the circumference or the length of the brake gap. Local magnetic field concentrators are formed by radially protruding arms or by a star contour, which lead to a local increase in the field strength in the brake gap. This increases the engagement and clumping of individual non-round particles with one another.

In all of the configurations, it is also possible for the two brake components to be movable linearly with respect to one another, at least in sections. In this case, the two brake components can be moved relative to one another axially, linearly or along a cam track or a link guide.

It is possible for at least one rotary body to be arranged in at least one gap section of the braking gap. Such a rotating body can, for example, as a sphere or be designed in particular as a roller and can also lead to the (geometric) wedge effect described from the prior art, which also leads to clumping or latching of the engagement structure. As a result, the maximum torque that can be generated or the maximum braking force that can be generated is again significantly increased.

In all of the configurations it is possible for the magnetorheological medium to comprise at least one liquid as the carrier medium, in which the magnetically polarizable particles are accommodated. The proportion of the magnetically polarizable particles is in particular between 25 and 50 percent by volume (in the receiving space). In particular, a proportion by volume of between 25 and 40% of polarizable particles is provided.

In particularly preferred configurations, the magnetorheological medium comprises at least one gas, which surrounds the magnetically polarizable particles as a carrier medium. It is then possible that no liquid is provided as the carrier medium. In the case of (dry) magnetically polarizable particles, the proportion of the particles in the receiving space is in particular between 40 and 90 percent by volume and preferably between 50 and 80 percent by volume.

In all configurations it is preferred that the device comprises an operating element connected to the magnetorheological braking device. The operating element can, for example, be in the form of an operating roller and/or comprise an operating button. The magnetorheological braking device is preferably accommodated at least partially in the interior of the operating element.

It is possible and preferred that the operating element has an outer diameter of less than 75 mm and in particular less than 60 mm and preferably less than 50 or less than 45 mm. In the configuration as an operating roller, the operating element can also Have a diameter of less than 25 mm or less than 15 mm.

In another embodiment, the device for braking relative movements has at least two braking components, a receiving space with a braking gap being formed between the braking components and containing a magnetorheological medium with magnetically polarizable particles that can be influenced by a magnetic field. At least one electric coil unit is included to generate a controllable magnetic field in the braking gap. A minimum gap height of the braking gap between the braking components is smaller than ten times, eight times or five times the mean diameter of a typical magnetically polarizable particle in the braking gap.

In yet another embodiment, the device for braking relative movements comprises at least two braking components, wherein a receiving space with a braking gap is formed between the braking components and contains a magnetorheological medium with magnetically polarizable particles that can be influenced by a magnetic field. In this case, an electrical coil unit is included in order to generate a controllable magnetic field in the braking gap. The magnetically polarizable particles include non-round particles in which a ratio of the maximum diameter to a maximum transverse extent perpendicular thereto is greater than 1.25 or 1.5 or 2.0.

The method according to the invention is used to brake relative movements of at least two brake components of a magnetorheological brake device, wherein a receiving space with a brake gap is formed between the brake components and contains a magnetorheological medium with magnetorheological or polarizable particles that can be influenced by a magnetic field. With an electric coil unit, a magnetic field is generated in the brake gap to under the influence of the magnetic field over at least a part of the to form an engagement structure with magnetically polarizable particles in the brake gap and to wedge magnetically polarizable particles on it with one another.

The magnetic field strength between the individual particles is preferably more than 500 kA/m in the braking gap. In particular, the particle concentration in the braking gap is greater than 40%.

In the prior art with the active principle of shearing, a chain formation of the carbonyl iron particles is generated in a braking gap. The strength of the chain formation depends on the strength of the magnetic field. In addition, the shear stress that can be generated can be easily controlled and directly influenced.

In the present invention, a braking torque is generated in the braking gap at low field strengths, as in the prior art shear. At higher field strengths, clumping or engagement of the particles occurs. However, this does not require the use of rotary bodies in the braking gap. Due to their non-round structure, the individual particles can engage in one another and form an engagement structure with one another, which (even without rolling elements or the like) generates high and very high braking forces. The transition to lump formation is progressive and not directly and immediately related to the shear stress. According to the current state of knowledge, the field strength (a very high field strength) triggers the formation of clumps. The formation of lumps or the latching or wedging of the magnetically polarizable 14 particles with one another is a mechanical process and cannot be controlled very easily. In particular, when “dry” particles are used with a gas or gas mixture without the use of oil, a particularly low basic torque can be achieved, while a high static braking torque can be generated when lump formation is triggered. If rotating bodies or rollers are also used, an even (much) higher braking torque can be generated.

An advantage of smaller gap heights compared to the prior art is that a noticeable acceleration of the reaction speeds or a noticeable increase in the response behavior is perceptible. This could be because a smaller number of particles need to be aligned, producing an effect more quickly. It has been found that the haptic feeling during operation can be improved because, on the one hand, the reaction speed can be increased and, on the other hand, the maximum braking torque or the maximum braking force can be increased. This is made possible to a considerable extent by the particle structure. The particles are designed in such a way that they form an engagement structure and can jam together.

It is particularly advantageous if very high flux densities with very high field strengths are achieved in the braking gap, the braking gap has a small height and non-round or misshapen particles or particles that can be engaged together and in particular carbonyl iron particles are used in high concentrations. Then the aforementioned effects occur and the individual particles become engaged or clumped together. Several individual particles stick together due to the magnetic field forces (rheological chain formation), somewhat like a Velcro fastener. They form larger structures like lumps, which in turn lead to latching or wedging with high tangential forces in the brake gap. With a suitable design of the magnetic field 9 strength or flux density, the braking gap height and the number, type and shape of the particles, this effect does not require a mechanical (geometric) wedge shape as in the prior art or a special shape of the braking gap. Even with two mutually parallel or concentric surfaces, lump formation occurs with engagement, wedging, jamming or clogging and high tangential forces, which in turn lead to high braking torques and damping forces. This is not caused by the shear stresses between the individual freely moving (round) particles, but rather by the interlocking of the individual non-round and misshapen (non-spherical) particles in the brake gap.

Magnetic field forces between or to the individual particles are the trigger and the resulting shear stresses are multiplied by clumping to high braking forces or high braking torques.

It is advantageous if the gap height of the braking gap is smaller than in the prior art. Because the higher the gap height (relative to the dimensions of the particles), the more likely it is that the particles linked together will break up or separate. The behavior is not linear, i.e. the braking torque decreases disproportionately as the gap height increases.

Therefore, small braking gap heights are progressively effective. If the particles get larger, the gap height can be chosen correspondingly larger. If the particles become smaller, it makes sense to choose a correspondingly smaller gap height.

A very high and above-average magnetic field strength (flux density) in the brake gap is very advantageous. Advantageous values are well above the values mentioned in the literature or necessary for shearing. When shearing according to the prior art, a flux density of between 50 and 100 kiloamperes/meter is usually generated, since there is a linear increase in the shear stresses in this range. In the range between 150 and 250 kiloamperes/meter, the curve flattens out considerably. Higher flux densities (to be generated by the electric coil) only lead to smaller increases in shear stress, so that the system becomes ineffective (es goes into saturation).

In the case of pure shear, very high flux densities therefore make no sense or only lead to a small and inefficient increase in the shear stresses and thus the braking torque. High flux densities require correspondingly large magnetic field circuits and powerful electrical coil units. All in all, this means more weight, space requirements and costs.

Small brake gap heights place high demands on production and, according to the prior art, also make no sense in braking devices based on the shearing principle or do not lead to an increase in the tension and thus the braking torque. Therefore, based on the prior art, one would not combine a small braking gap height with a very high field strength or flux density and misshapen or non-round particles, since this would presumably result in an unfavorable end product. Correctly coordinated, however, they surprisingly produce a disproportionate braking effect.

With a ring-cylindrical braking gap and a given installation space, there are certain cross-sections through which the magnetic field flows. Normally, the specialist designs the magnetic circuit in such a way that there are no constrictions or bottlenecks caused by the magnetic field. The braking gap is charged with the flux density according to the state of the art. However, this does not lead to the formation of lumps in the brake gap as described here. However, higher flux densities in the brake gap cannot be achieved because the magnetic circuit is magnetically saturated in the core area due to the space requirements. Therefore, the annular braking gap sees a lower flux density. However, in order to increase the braking torque, one would not reduce the shearing surface of the braking gap (shearing surface=effective surface), since according to the literature this would lead to a reduction in the braking torque. Half the shearing area results in half the braking torque. It would therefore be absurd to use the shearing surface (effective surface) in the braking gap to be reduced, as this would proportionally reduce the transmissible shear stresses and thus the braking torque.

However, to get the best results, you have to do exactly that to keep the clumping going. By reducing the shearing area in the braking gap at the transition area from the solid metal to the carbonyl iron powder (particles), the flux density between/in the carbonyl iron powder (particles) is increased by reducing the shearing area in the remaining active gap, which in turn leads to the formation of lumps of the individual particles.

If you have a magnetorheological damper with magnetorheological fluid, which is designed according to the above invention, and fills it only with carbonyl iron powder, i.e. instead of 40 percent by volume of particles in the case of magnetorheological fluid, you then have up to 80 percent by volume of particles (because the space-consuming carrier fluid is missing), you would Expect noticeably higher braking torques. The opposite is the case. The transition/effective area at the transition area to the braking gap should be reduced so that the flux density/field strength in the remaining area increases, which then leads to clumping in the braking gap and significantly higher braking torques due to the higher flux density.

These braking torques are e.g. higher by a factor of 4 to 10 than with pure shearing according to the prior art. This means that, for example, a shearing area (effective area) reduced by half due to the lump formation that is generated as a result still delivers higher braking torques by a factor of 4, although according to the literature these should drop noticeably because the shearing area first decreases and the increase in flux density/field strength is actually due to this of the flattening shear stress curve (with higher kA/m) would have to lead to a significantly lower increase in moment. In fact, significant amplification can be achieved.

In all configurations it is preferred that the receiving space is filled to less than 95 percent by volume with magnetorheological particles. In particular, the magnetorheological particles can each consist predominantly of carbonyl iron powder. The particles can have a coating against corrosion. The magnetorheological medium may include a graphite additive.

In particular, the magnetically polarizable particles have a packing density of more than 74%. For the magnetically polarizable particles, geometries and/or size distributions are preferably provided which enable an improved packing density and particularly preferably a packing density of more than 74%.

In particular, at least some of the magnetically polarized particles each have at least one positive-locking structure. In particular, the form-fitting structures of the individual particles interact, resulting in the engagement structure. The positive-locking structure is provided in particular by at least one of the previously described geometric properties of the particles. In particular, the particles engage in one another in a form-fitting manner by means of their form-fitting structures and thereby provide the engagement structure.

In all of the configurations, it is possible for a torque sensor or torque recorder or torque observer or a force sensor to be included. Such a sensor can be embodied as a strain gauge, but is not limited thereto. It is also possible to use a passive magneto-elastic strain measurement (magnetostriction), an active magnetic-inductive strain measurement (inverse magnetostriction) or a fiber-optic strain measurement.

Further advantages and features of the present invention result from the exemplary embodiments, which are explained below with reference to the attached figures.

Show in it:

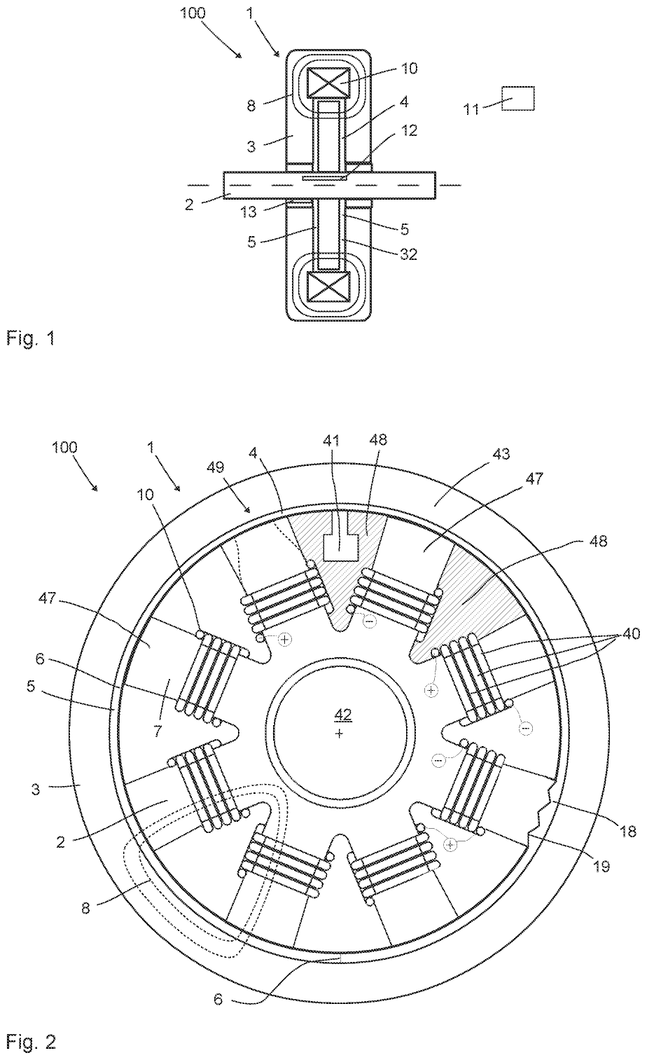

FIG. 1 shows a highly schematic exemplary embodiment of a device according to the invention with a magnetorheological braking device;

FIG. 2 shows another exemplary embodiment of a device according to the invention;

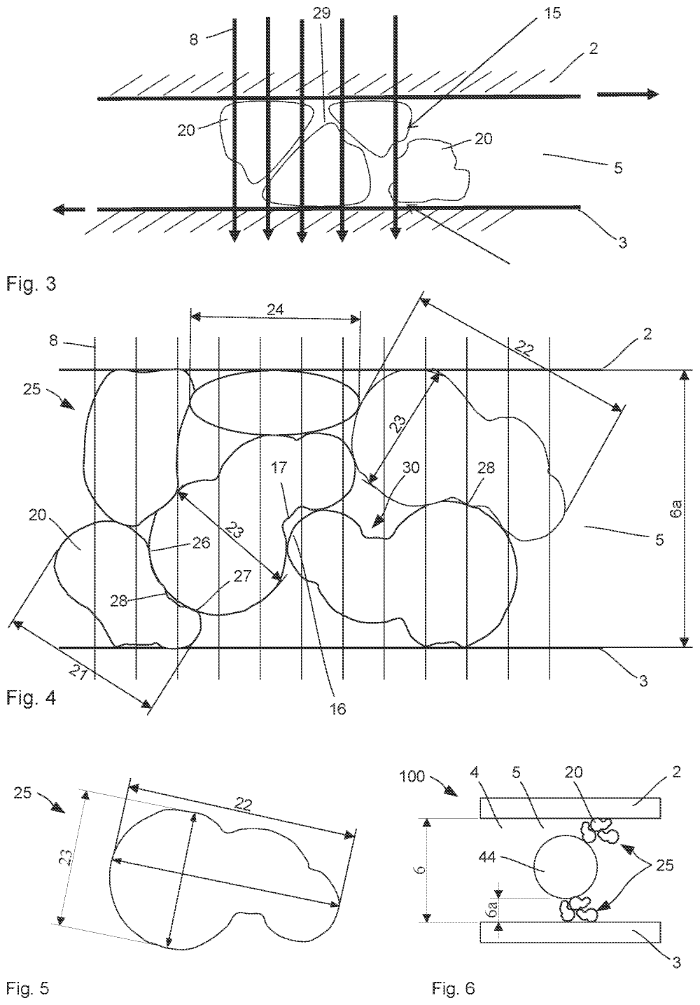

FIGS. 3 and 4 show schematic representations of a braking gap of a device according to the invention;

FIG. 5 shows a highly schematic representation of a magnetically polarizable particle;

FIG. 6 shows a further exemplary embodiment of a device according to the invention;

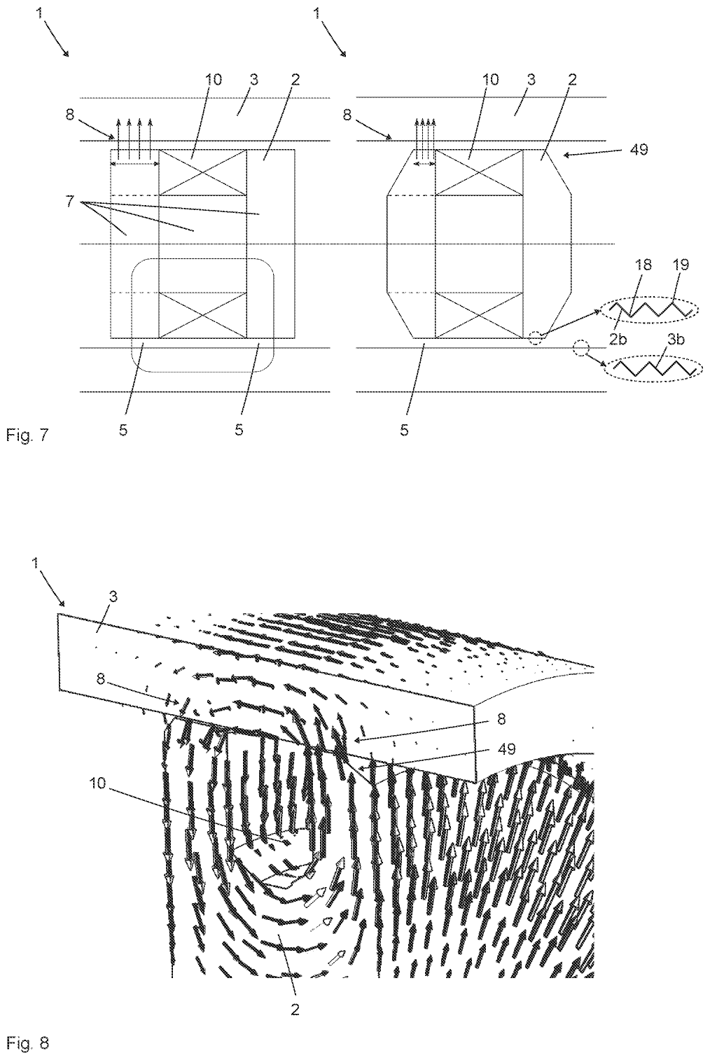

FIG. 7 shows two schematic cross sections of a further device according to the invention;

FIG. 8 shows the simulation of the course of the magnetic field in a device according to FIG. 7;

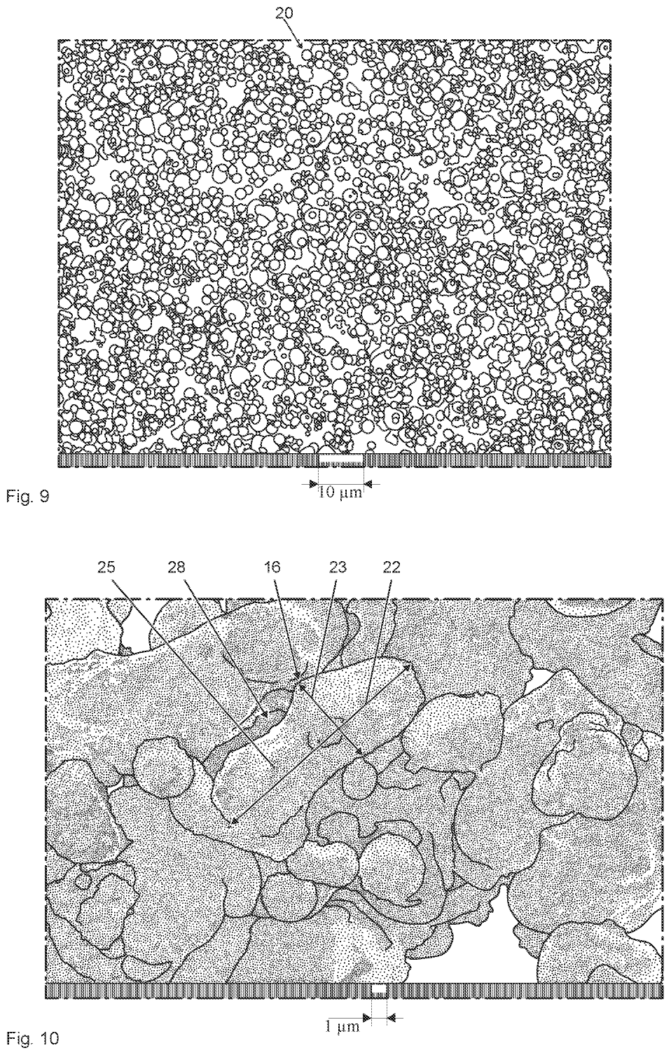

FIGS. 9 and 9a show a scanning electron micrograph of conventional magnetorheological particles; and

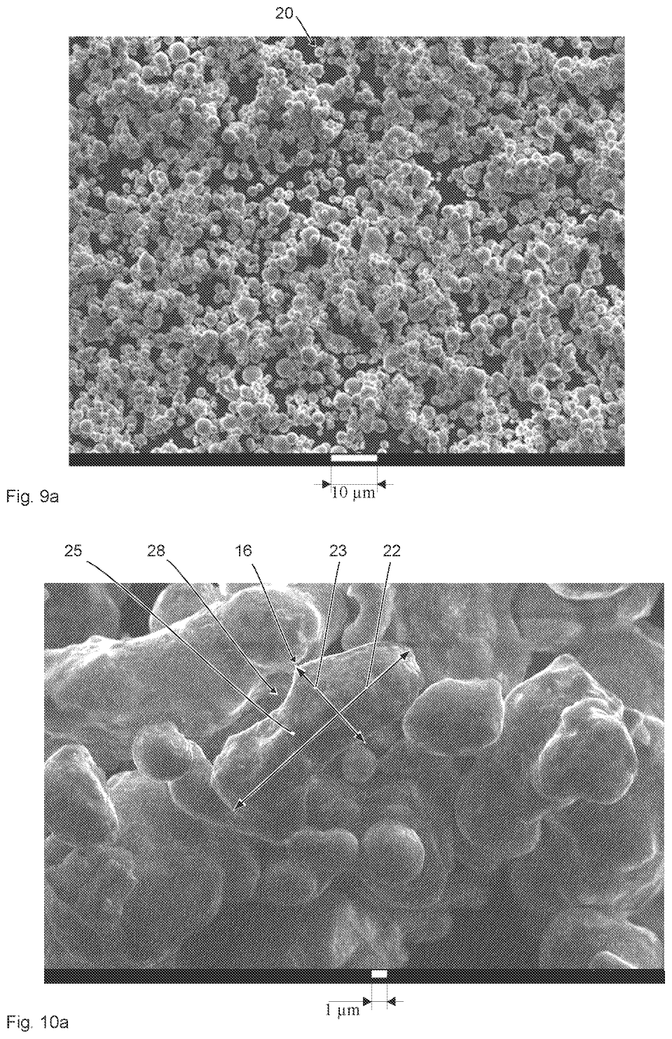

FIGS. 10 and 10a show a scanning electron microscope image of magnetorheological particles for the braking device according to the application.

FIG. 1 shows a highly schematic sectional representation of a device 100 according to the invention, which includes a braking device 1 or is designed as such. The braking device 1 comprises an internal braking component 2, which is designed as an internal component 2a, and an external braking component 3 surrounding it, which is designed as an external component 3a. A brake disk 32 is firmly connected to the brake component 2 here. The brake component 3 surrounds the brake disk 32 and forms a receiving space 4 between the brake disk 32 and the brake component 3, which is provided with a magnetorheological medium 9 with magnetorheological particles 20. A brake gap 5 is formed between the brake disk 32 and the brake component 3 on each side of the disk 32 and radially on the outside. The brake component 3 forms a housing.

The magnetic field lines 8, which are generated by the electric coil unit 10, pass through the lateral braking gaps 5 and, depending on the magnetic flux density, cause the individual magnetorheological particles 20 to be linked or clumped or engaged (compare FIGS. 3 and 4).

A control unit 11 is used to control the electric coil unit 10 and thus the strength of the magnetic field 8. A load sensor 12 and a position sensor 13 are used to detect the relative position of the two brake components to one another and to detect the braking torque generated.

In all of the exemplary embodiments, ferromagnetic and/or ferrimagnetic and/or superparamagnetic particles and preferably at least particles of carbonyl iron powder are preferably provided. A magnetorheological medium that is made available from carbonyl iron powder in ambient air can be used particularly advantageously. There may also be additives that improve lubrication in particular. The particles can e.g. have a particle size distribution between one and in particular between five or ten and twenty micrometers. Also possible are smaller (<1 micron) to very small (a few nanometers) or larger particles of thirty, forty and fifty microns or even larger.

Brake gaps 5 are provided between the brake components 2 and 3, which have a gap height and are filled with a medium here. The medium can also be a magnetorheological fluid which, for example, comprises an oil as a carrier liquid in which ferromagnetic (magnetorheological) particles 20 are present. Glycol, grease, silicone, water, wax, and thick or thin materials can also be used as the carrier medium, but are not limited to these.

However, the carrier medium is in particular and particularly preferably also gaseous and/or can be a gas mixture (e.g. air or ambient air, nitrogen, gas or gas mixture, air mixture) or the carrier medium can be dispensed with (vacuum or air and e.g. ambient air). In this case, only particles that can be influenced by the magnetic field (e.g. carbonyl iron) are filled into the braking gap or active gap. A mixture with other—preferably with lubricating properties, but not limited to-particles such as graphite, molybdenum, plastic particles, polymeric materials are possible. It can also be a combination of the materials mentioned (e.g. carbonyl iron powder mixed with graphite and air as a carrier medium). As a carbonyl iron powder without a (liquid) carrier medium, a powder can be used, for example, which contains a minimum iron content of 97%, e.g. a SiO2 coating.

The ferromagnetic or ferrimagnetic particles 20 are preferably carbonyl iron powder. The particles can also have a special coating/shell (titanium coating, ceramic, carbon shell, polymeric coating, etc.) so that they can better withstand the high pressure loads that occur depending on the application or are stabilized. The particles can also have a coating against corrosion or electrical conduction. The magnetorheological particles can account for this application not only from carbonyl iron powder (pure iron; iron pentacarbonyl), but e.g., also made of special iron (harder steel) or other special materials (magnetite, cobalt . . . ), or a combination thereof. Low hysteresis superparamagnetic particles are also possible and advantageous.

FIG. 2 shows an alternative embodiment in which a ring-cylindrical braking gap 5 is formed between the two braking components 2 and 3. A core 7 is formed on the axle unit 42, which here comprises a plurality of arms 47 protruding radially outwards. The arms 47 can be finger-like or extend considerably in depth in the form of ribs, so that the length perpendicular to the plane of the page can also be greater than the diameter in the plane of the page. In principle, it is possible with (adapted modifications) of the braking device 1 according to FIG. 2 to brake or dampen both linear movements perpendicular to the plane of the page and rotary movements.

Each individual arm 47 here has a plurality of windings of an electrical coil unit 10 in order to generate a corresponding magnetic field. The magnetic field 8 passes essentially radially through the braking gap 5 and runs in the outer braking component 3, which can be embodied as a rotor unit 43, in the circumferential direction to the next arm 47, where it again passes essentially radially through the braking gap 5.

Between the individual arms 47, intermediate sections 48 are provided or formed here, which are in particular filled with a material with a significantly lower magnetic permeability than the magnetic permeability of the arms 47. The ratio of the relative magnetic permeability of the arm 47 to the relative magnetic permeability of the intermediate section 48 is preferably greater than 10 and in particular greater than and particularly preferably greater than 1000 and can reach or exceed values of 10,000 or 100,000.

If a magnetorheological fluid is used with a carrier material such as an oil or the like, a compensating tank 41 can be provided. If “dry” particles 20 with a gas or gas mixture are used as the magnetorheological medium 9, a compensating tank (temperature compensation, leakage compensation, etc.) can be dispensed with.

The radially outer end of an arm 47 can be tapered in order to produce a greater concentration of the field strength in the braking gap, see the constriction 49 at the top of the illustration in FIG. 2. It is also possible that the radially outer end of one or more arms 47 have a star contour or a wavy shape, as shown in the lower right area, in order to still achieve some reinforcement in certain sections over the surface of the arm. There elevations 18 and depressions 19 are located. Corresponding contours in the housing, which reduce the effective areas and thus increase the field strength in the transition areas, are also possible as an alternative or in addition.

FIG. 3 shows a highly schematic sectional illustration through the braking gap of a braking device 1. Magnetic field lines 8 which pass through the braking gap 54 perpendicularly are shown schematically in the braking component 2 and the braking component 3.

In the brake gap 5 four magnetorheological particles 20 are shown schematically here, which are non-round and can thus form an effective engagement structure 15 overall. An edge 29 is attracted to one of the magnetorheological particles 20 as an example. It is evident that the type and structure of the magnetorheological particles 20 result in an effective clamping of the individual particles to one another and of the two braking components 2 and 3 relative to each other.

In the case of carbonyl iron powder according to the prior art, we are talking about a brake gap height of preferably <1 mm, particularly preferably about 0.1 mm with an actuator diameter of <40 mm, for example.

A smaller gap height is preferred here. If larger particles are used, the active gap thickness/height can also increase. If smaller particles are used, the active gap thickness/height must also be smaller.

FIG. 4 shows a further schematic cut cross-sectional view of a braking device 1, in which a number of misshapen magnetorheological particles 20 are drawn. The braking gap extends between the two braking components 2 and 3. In the active gap or braking gap 5, a plurality of particles 20 are shown schematically. The particle drawn in at the top right has a maximum diameter 22 which is considerably larger than the maximum transverse extent 23 perpendicular thereto. Some of the particles have trough sections 28, projections 16, or recesses 17 which can be engaged by other sections of other particles. This creates an overall effective engagement structure as the particles engage. There may be even smaller particles between the particles shown. These can also be spherical. The latching and wedging of the individual particles is promoted by a high magnetic field strength in the brake gap 5, as a result of which the particles are also attracted to one another, which intensifies the formation of lumps. The mean diameter 21, averaged over all particles, or the typical diameter 24 of the particles 20 can differ from the maximum diameter and the maximum transverse extent 23. A large surface area of the particles per volume is advantageous.

For example, rather flat particles are advantageous. The surface as such can also be rough and/or wavy. It has been found that a relatively small minimum gap height 6a is beneficial for increasing the braking torque, while too great a distance between the two braking components 2 and 3 leads to a reduction in the braking torque that can be achieved. If the surface of one or both brake components is not smooth, the minimum gap height 6a can be correspondingly reduced by elevations or depressions.

FIG. 5 shows a schematic representation of an individual particle 20 which is in the form of a non-round particle 25. The ratio of the maximum diameter 22 to the maximum transverse extent perpendicular thereto is more than 1.25 here and can reach and exceed values of 1.5 or 2.

FIG. 6 shows a highly schematic depiction of a device 100 with a braking device 1, rotating bodies 44 in the form of rollers or the like being provided in the braking gap 5. As a result, the minimum gap height 6a of the braking gap 5 is considerably smaller than the gap height 6 between the braking components 2 and 3. In this exemplary embodiment, too, misshapen and non-round particles 25 are used, which lead to clumping and engagement of the individual particles 20, so that a particularly high braking torque can be achieved.

The magnetically polarizable particles from e.g. FIGS. 3 to 6 engage, in particular three-dimensionally. The effective surfaces of the brake components 2 and/or 3 that are in contact with the particles can also have a corresponding surface and/or surface quality, which requires engagement with the particles. These can have troughs, edges, pyramids, indentations and bulges, corners, dimples and the like. The surfaces can be rough and also irregular. Preferably, a height difference from the “lowest” to the “highest” point of a surface is greater than 1% or 5% of the gap height in the braking gap 5 and/or greater than 5% or 10% of the diameter of a particle.

FIG. 7 shows two schematic cross sections of braking devices 1, each with two braking components 2, 3, with a braking gap 5 being formed between the surfaces 2b, 3b. An electric coil unit 10 is wound around a core 7, which can be formed in one piece or consist of several parts. In the representation on the right of FIG. 7, the core is tapered in the radially outer area and thus has a radially outer constriction 49 12. As a result, the magnetic field lines of the magnetic field 8 are concentrated and run “narrower” than in the illustration on the left in FIG. 7, in which the core 7 has no constriction 49 or tapering at the radially outer end.

On the right next to FIG. 7, possible configurations of the (outer) surface 2b of the brake component 2a and the (inner) surface of the brake component 3 are shown schematically on an enlarged scale. In this case, elevations 18 and depressions 19 can be formed regularly or irregularly on the surfaces 2b and 3b in order to promote and reinforce engagement of the particles with the braking components. This effectively reinforces the engagement structure.

By changing the geometry at the active gap, as shown in FIG. 7, the magnetic field 8 can be specifically strengthened at certain points and thus weakened at others. This is shown schematically in FIG. 7 in rotationally symmetrical dampers, the magnetic field automatically decreases radially, since the magnetic field has to flow through a larger area. The effective gap, which has a larger radius than the core around which the electrical coil unit is wound, therefore has a lower field strength than in core 7, even if the axial diameters are the same as in core 7. An increase in the current in above a certain field strength, the coil unit would no longer be of any use, since the core 7 gets into magnetic saturation.

However, a high magnetic field is necessary for the effects described according to the invention. Therefore, the effective area on braking gap can be reduced to increase the magnetic field 8. So you lose shear area, but at the same time you get a larger magnetic field.

FIG. 8 shows a schematic of a magnetic field simulation for two different geometries, with the centrally provided coil unit 10 not being shown. It can be seen that the magnetic field is stronger with a narrower effective area (denser and longer vectors=higher magnetic field, vectors further apart and shorter=lower magnetic field). Different constrictions 49 (different angles) are formed at the radially outer end of the core 7 at the right and left ends of the core 7. The remaining web at the braking gap is therefore different in width on the right and left. At the right end, the remaining web is narrower, so that a locally stronger magnetic field penetrates the braking gap 5. The shearing surface is narrower, but the magnetic field strength is significantly higher, so that the particles can engage.

FIGS. 9 and 9a show a scanning electron microscope image as a line drawing and as an image of a conventional magnetorheological fluid, the round particles 20 being clearly visible. The scale and a stretch of 10 ym are shown on the edge.

In contrast to the particles according to FIG. 9, non-round particles 25 according to FIG. 10 (as a line drawing) or FIG. 10a (as a photograph) are used according to the invention to a significant extent. In the representation according to FIGS. 10 (and 10a), it can be seen directly that a significant proportion of the particles 20 or the majority of them are non-round and misshapen. In the case of the particle 20 shown in the center, the maximum diameter 22 is more than twice as large as the maximum transverse extent 23 of the same particle 20 perpendicular thereto. In principle, FIGS. 9 and 9a show the same section. Likewise, FIGS. 10 and 10a basically show the same detail.

On the particles 20, both projections 16 and trough sections 28 are formed. An effective engagement structure 15 in the braking gap 5 is made possible by a corresponding number of particles 20 designed in this way. Even if the scale according to FIG. 8 (compare the 1 μm distance shown) is considerably larger than the scale according to FIG. 7, it is clear that the structure of the particles 20 in FIG. 8 is considerably different than in FIG. 7. This achieves a significantly better clamping of the individual particles 20 with one another and thus of the brake components 2 and 3.

Particles according to FIG. 9 (9a) can be combined with particles according to FIGS. 3 to 6 and/or 10 (10a) are mixed and thus result in the magnetorheological medium. In particular, a proportion of at least 10% or 20% of non-round particles is used. The proportion of non-round particles is preferably at least 30% or 40% or 50% or more.

The magnetic attraction between particles depends on the volume and the surface area. Spheres have the smallest surface area for a given volume. Since the magnetic attraction force is proportional to the (touching) surface area, the force between two spherical particles is less than for differently shaped (non-spherical) particles with the same volume, e.g. for cubes or the particle shapes described here. Larger particles therefore also attract with greater force, since the flux density increases with larger volume.

Spherical or globular particles with the same diameter have a maximum packing density that cannot be exceeded. This is about 74%. Other shaped (non-spherical) particles can be packed more densely. As a result, the empty space or the air volume in the gap can be reduced. The magnetic resistance in the gap decreases and the magnetic circuit becomes more efficient. The magnetic flux is then increased with the same installation space, which is particularly advantageous in the case of small installation volumes. The particles then themselves reinforce the field they need to form the engagement structure.

Particularly when using a magnetorheological medium in which a gas or gas mixture and no liquid components are used as the carrier material, a particularly low basic torque can be achieved, while on the other hand a particularly high maximum braking torque can be achieved. A particularly high braking torque is achieved with high flux densities in the braking gap and a relatively low minimum gap height 6a and with non-round particles 20.

In the case of smooth or round or spherical particles, a correspondingly strong magnetic field is necessary so that the particles adhere or rub together so strongly that the desired braking effect occurs. If the magnetic field is insufficient, the particles slide along each other. In the case of the invention, the engagement structure is formed between the individual particles 20 even with weaker magnetic influences, so that, for example, form-fitting and cannot slide along each other. This means that the brakes can be particularly strong if necessary. In addition, due to the properties described here, the particles have the advantage that they also enable a particularly low basic torque. As a result, the brake components can be rotated relative to one another particularly easily when no magnetic field is generated.

### REFERENCE LIST

1 braking device 23 maximum transverse extent
2 brake component (inner) 24 typical diameter
2a interior component 25 non-round particles
2b surface 26 location of magnetic influence
3 brake component (external) 27 location of magnetic influence
3a external component 28 trough section
3b surface 29 edge
4 receiving space 30 angled structural section
5 brake gap 32 brake disc
6 gap height 40 winding
6a minimum gap height 41 compensation containers, reservoir
7 core 42 axle unit
8 magnetic field 43 rotor unit
9 magnetorheological medium 44 rotating bodies
10 coil unit 45 gap section
11 control unit 46 variable gap height
12 load sensor 47 arm
13 position sensor (path, angle) 48 Intermediate section
14 magnetic field sensor 49 constriction
15 engagement structure 50 console
16 projections 59 fastening device
17 recesses 100 device
18 elevation 101 control element, operating
19 depressions element
20 particles 102 outer diameter
21 mean diameter 103 operating roller
22 maximum diameter 104 control button

1-39. (canceled)

40. A device with a magnetorheological braking device for braking relative movements, comprising:
at least two braking components;
a receiving space with a braking gap being formed between the at least two braking components, containing a magnetorheological medium with magnetically polarizable particles that can be influenced by a magnetic field;
at least one core and at least one electric coil unit being configured to generate a controllable magnetic field in the brake gap; and
at least some of the magnetically polarizable particles being configured to form an engagement structure and latch together under the influence of the magnetic field.

41. The device according to claim 40, wherein the magnetic field strength between the individual magnetically polarizable particles is greater than kA/m.

42. The device according to claim 40, wherein a minimum gap height of the braking gap between the braking components is less than five times a mean diameter of a typical magnetically polarizable particle in the braking gap.

43. The device according to claim 40, wherein the magnetically polarizable particles are non-round particles and a ratio of the largest diameter the particles to the largest transverse extent perpendicular thereto is greater than 1.25 or 1.5.

44. The device according to claim 40, wherein at least some of the magnetically polarizable particles are configured to latch together over a large area under the influence of the magnetic field.

45. The device according to claim 40, wherein at least some of the magnetically polarizable particles are configured to latch together under the influence of the magnetic field at two or more locations spaced apart from one another.

46. The device according to claim 40, wherein at least some of the magnetically polarizable particles have at least one trough section.

47. The device according to claim 40, wherein at least some of the magnetically polarizable particles have an angled structural section.

48. The device according to claim 40, wherein:
at least some of the magnetically polarizable particles have a projection or edge portion;
at least some of the magnetically polarizable particles have a recess or trough portion; and
the projection or edge portion of at least one particle interlocks with the recess or trough portion of another particle.

49. The device according to claim 40, wherein at least one surface of at least one braking component adjoining the braking gap is at least partially non-smooth and has elevations and/or depressions configured to reinforce an engagement with the particles.

50. The device according to claim 40, wherein a magnetic field strength greater than 150 kA/m can be generated in the braking gap.

51. The device according to claim 40, wherein a minimum gap height of the braking gap between the braking components is smaller than five times the largest diameter of the magnetically polarizable particles in the braking gap.

52. The device according to claim 40, wherein a minimum gap height of the braking gap between the braking components is greater than twice the maximum transverse extension perpendicular to the maximum diameter of the magnetically polarizable particles in the braking gap.

53. The device according to claim 40, wherein at least 25% of the magnetically polarizable particles have a ratio of maximum diameter to maximum transverse extension greater than 1.25.

54. The device according to claim 40, wherein at least 50% of the magnetically polarizable particles have a ratio of maximum diameter to maximum transverse extension greater than 1.25.

55. The device according to claim 40, wherein at least 25% of the magnetically polarizable particles have a maximum diameter and/or maximum transverse extension of at least 10 μm.

56. The device according to claim 40, wherein at least 25% of the magnetically polarizable particles have a maximum diameter of at least 30 μm.

57. The device according to claim 40, further comprising a load sensor and/or a force sensor.

58. The device according to claim 40, further comprising at least one position sensor.

59. The device according to claim 40, further comprising a control unit configured for controlling the electrical coil unit.

60. The device according to claim 40, wherein the two brake components are pivotable relative to one another and/or are continuously rotatable relative to one another.

61. The device according to claim 40, wherein one brake component has an inner component, the other component has an outer component, and the outer component at least partially surrounds the inner component radially.

62. The device according to claim 61, wherein the inner component is coupled to an axle unit.

63. The device according to claim 40, wherein the electrical coil unit is wound radially or axially around the core.

64. The device according to claim 40, wherein the core has at least one radially projecting arm around which at least one winding of the electrical coil unit is wound.

65. The device according to claim 40, wherein the core has a plurality of radially outwardly extending arms and intermediate sections between the arms, the arms are made of a material with a higher magnetic permeability relative to the magnetic permeability of the intermediate sections, and a ratio of the magnetic permeability of an arm to a magnetic permeability of an intermediate section is greater than 100.

66. The device according to claim 40, wherein the braking gap completely surrounds the inner component and the braking gap is configured as a circumferential annular gap.

67. The device according to claim 40, wherein at least one brake component has a star contour which projects towards the other brake component and which generates/provides a gap height that is variable over the circumference or length of the brake gap.

68. The device according to claim 40, wherein the two brake components are at least partially linearly movable relative to each other.

69. The device according to claim 40, further comprising at least one rotary body arranged in a gap portion of the braking gap.

70. The device according to claim 40, wherein the magnetorheological medium has at least one liquid as a carrier medium in which the magnetically polarizable particles are accommodated, and the magnetically polarizable particles make up between 25 and 50 percent by volume in the receiving space.

71. The device according to claim 40, wherein the magnetorheological medium has at least one gas as the carrier medium surrounding the magnetically polarizable particles, and the magnetically polarizable particles make up between and 90 percent by volume in the receiving space.

72. The device according to claim 40, further comprising an operating element connected to the magnetorheological braking device.

73. The device according to claim 72, wherein the operating element has a control roller and/or a control button, and the magnetorheological braking device is at least partially accommodated inside the control element.

74. The device according to claim 72, wherein the operating element has an outer diameter of less than 75 mm.

75. A device for braking relative movements, comprising:
at least two braking components;
a receiving space with a braking gap between the at least two braking components;
a magnetorheological medium with magnetically polarizable particles inside of the braking gap;
at least one electric coil unit being configured to generate a controllable magnetic field in the brake gap configured to influence the magnetorheological medium; and
a minimum gap height of the braking gap between the braking components is less than five times the mean diameter of the magnetically polarizable particles in the braking gap, and/or that the magnetically polarizable particles are non-round particles in which a ratio of the maximum diameter to a maximum transverse extent perpendicular thereto is greater than 1.25 or 1.5.

76. A method for braking relative movements of at least two braking components of a magnetorheological braking device, comprising:
providing an electric coil unit, and a receiving space with a braking gap formed between the braking components;
providing a magnetorheological medium in the receiving space that can be influenced by a magnetic field and has magnetically polarizable particles therein; and
generating a magnetic field in the braking gap with the electric coil unit, and under the influence of the magnetic field, forming an engagement structure in the braking gap and wedging magnetically polarizable particles thereon.

77. The method according to claim 76, wherein the magnetic field strength between the individual particles is greater than 500 kA/m.

78. The method according to claim 76, wherein the particle concentration in the brake gap is greater than 40%.
